(19) United States
(12) Patent Application Publication
(10) Pub. No.: US 2026/0219994 A1
(43) Pub. Date: Jul. 30, 2026

(54) APPARATUS FOR GENERATING DATA RECOVERY INFORMATION OF NAND FLASH MEMORY

(71) Applicant: DOUBLEO CO., LTD., Busan (KR)

(72) Inventors: Jongmin KIM, Busan (KR); MyoungHwan JOUNG, Busan (KR)

(73) Assignee: DOUBLEO CO., LTD., Busan (KR)

(21) Appl. No.: 19/148,933

(22) PCT Filed: Jul. 5, 2024
(86) PCT No.: PCT/KR2024/009527

§ 371 Date: Jul. 17, 2025

(30) Foreign Application Priority Data
Nov. 16, 2023 (KR) 10-2023-0159057

(51) Int. Cl. G06F 11/1446

(52) U.S. Cl. CPC G06F 11/1451; G06F 11/1469

(57) ABSTRACT

Proposed is an apparatus for generating data recovery information of NAND flash memory. In particular, provided is an apparatus for generating data recovery information of NAND flash memory, the apparatus being capable of recovering memory data in an environment in which an internal controller of a NAND flash memory device is unusable, by enabling parameter data of the memory to be loaded.

### TECHNICAL FIELD

The present disclosure relates to an apparatus for generating data recovery information of NAND flash memory, the apparatus being capable of recovering memory data in an environment in which an internal controller of a NAND flash memory device is unusable, by enabling parameter data of the memory to be loaded.

### BACKGROUND ART

Flash memory is semiconductor memory that can read and write data using electrical signals and retains the stored data even after power is interrupted. Although reading/writing is possible in particular units within the memory, erasure must be performed in block units. Therefore, once an area has been written, it must be erased before it can be written again.

Such flash memory can be largely divided into the NOR type having a parallel structure and the NAND type having a serial structure. Among these, the NAND type has slower data read speed than the NOR type, but its memory block is divided into multiple pages and thus has faster write or erase speeds and provides superior density per unit than the NOR type. For these reasons, the NAND type is mainly used in solid-state drives (SSDs) and USB memory devices.

A USB memory device is configured in a form in which a flash memory and a controller are separated into individual chips and integrated onto a single board. If physical damage or failure occurs in the device, the memory chip corresponding to the flash memory may be separated from the device board and mounted on a recovery device to which a data recovery program is applied, and then a data recovery operation is performed by reassembling dump data using parameter data of the memory chip through the data recovery program.

However, even when the data recovery program is used, it is a prerequisite that the controller, which controls the memory operation of the memory chip, operates normally in order to access the data area of the memory chip.

Therefore, if the controller itself has a problem and does not operate normally, it is difficult to recover the data of the memory chip.

### DISCLOSURE

### Technical Problem

Accordingly, the present invention has been made keeping in mind the above problems occurring in the related art, and the present disclosure is directed to providing an apparatus for generating data recovery information of NAND flash memory, the apparatus being capable of recovering memory data in an environment in which an internal controller of a NAND flash memory device is unusable, by enabling parameter data of the memory to be loaded.

### Technical Solution

According to an aspect of the present disclosure, there is provided an apparatus for generating data recovery information of NAND flash memory, the apparatus including: an image storage part configured to acquire and store either an image obtained by capturing a front side of a memory chip or an image of the front side of the memory chip according to a user input; a string extraction part configured to use a preset string extraction algorithm to extract a string included in the image stored in the image storage part; an ID data acquisition module configured to determine whether the string extracted by the string extraction part includes any one controller manufacturer name among a plurality of preset controller manufacturer names, and provide the controller manufacturer name included in the string as a query to an external ID data DB when it is determined that the string includes the manufacturer name, and acquire a controller product name and ID data corresponding to the controller manufacturer name provided as the query, wherein the external ID data DB pre-stores the controller product name and the ID data for each memory product corresponding to the controller manufacturer name and outputs the controller product name and the ID data when the controller manufacturer name is provided as the query; a data loading part configured to input, when the ID data is acquired, a call command value and a call address value that are a command for calling a parameter page area of the memory chip to an input/output terminal of the memory chip and load parameter data stored in the parameter page area; a mode classification part configured to extract binary data recorded at a particular byte position of the loaded parameter data and assign a mode classification value according to a result of comparison with a plurality of pieces of preset protocol signature information; and a recovery information generation part configured to generate parameter page recovery information by matching a byte-specific item value for the mode classification value and contents of the parameter data in byte order on the basis of parameter page length and byte-specific item value information preset in association with the assigned mode classification value.

### Advantageous Effects

Accordingly, according to the above-described present disclosure, even when physical damage or failure occurs in an internal controller of a NAND flash memory device, making the internal controller unusable, the memory chip can operate and execute commands, thereby acquiring parameter data required for recovering data.

In addition, according to the present disclosure, the controller manufacturer name written at the NAND flash memory is recognized, the ID data of the recognized controller manufacturer name is acquired through the external ID data DB, and NAND flash memory data can be recovered using the acquired ID data.

In addition, according to the present disclosure, a parameter page library for each memory chip can be built, so information required for recovering the data of the memory can be acquired in a short time using only a memory chip image or data recorded in the memory chip.

The effects of the present disclosure are not limited to the above-mentioned effects, and other effects not mentioned herein will be clearly understood by those skilled in the art from the description of the claims.

### DESCRIPTION OF DRAWINGS

FIG. 1 is a conceptual diagram briefly illustrating an apparatus for generating data recovery information of NAND flash memory according to an embodiment of the present disclosure,

FIG. 2 is a block diagram illustrating an apparatus for generating data recovery information of NAND flash memory according to an embodiment of the present disclosure,

FIG. 3 is a diagram illustrating an operation timing chart of commands input by an initial command input part and a data loading part of FIG. 2,

FIG. 4 is a diagram illustrating a part of a parameter page corresponding to a case of classification with a first classification value by a mode classification part of FIG. 2,

FIG. 5 is a diagram illustrating an example of a parameter page corresponding to a case of classification with a second classification value by a mode classification part of FIG. 2,

FIG. 6 is a flowchart illustrating a method for generating data recovery information of NAND flash memory according to another embodiment of the present disclosure,

FIG. 7 is a flowchart illustrating step S100 of FIG. 6 in detail,

FIG. 8 is a flowchart illustrating a data recovery process between step S500 and step S700 of FIG. 6,

FIG. 9 is a flowchart illustrating a library recommendation process after step S700 of FIG. 6, and

FIG. 10 is an example illustrating a user interface for searching an external ID data DB for ID data.

### BEST MODE

According to an aspect of the present disclosure, there is provided an apparatus for generating data recovery information of NAND flash memory, the apparatus including: an image storage part configured to acquire and store either an image obtained by capturing a front side of a memory chip or an image of the front side of the memory chip according to a user input; a string extraction part configured to use a preset string extraction algorithm to extract a string included in the image stored in the image storage part; an ID data acquisition module configured to determine whether the string extracted by the string extraction part includes any one controller manufacturer name among a plurality of preset controller manufacturer names, and provide the controller manufacturer name included in the string as a query to an external ID data DB when it is determined that the string includes the manufacturer name, and acquire a controller product name and ID data corresponding to the controller manufacturer name provided as the query, wherein the external ID data DB pre-stores the controller product name and the ID data for each memory product corresponding to the controller manufacturer name and outputs the controller product name and the ID data when the controller manufacturer name is provided as the query; a data loading part configured to input, when the ID data is acquired, a call command value and a call address value that are a command for calling a parameter page area of the memory chip to an input/output terminal of the memory chip and load parameter data stored in the parameter page area; a mode classification part configured to extract binary data recorded at a particular byte position of the loaded parameter data and assign a mode classification value according to a result of comparison with a plurality of pieces of preset protocol signature information; and a recovery information generation part configured to generate parameter page recovery information by matching a byte-specific item value for the mode classification value and contents of the parameter data in byte order on the basis of parameter page length and byte-specific item value information preset in association with the assigned mode classification value.

### MODE FOR INVENTION

Specific details including the objectives to be achieved by the present disclosure, the means for achieving the objectives, and the effects of the disclosure as described above are included in the embodiments and drawings to be described below. Advantages and features of the present disclosure, and methods to achieve them will be apparent from the following embodiments that will be described in detail with reference to the accompanying drawings. Throughout the description, the same reference numerals refer to same elements.

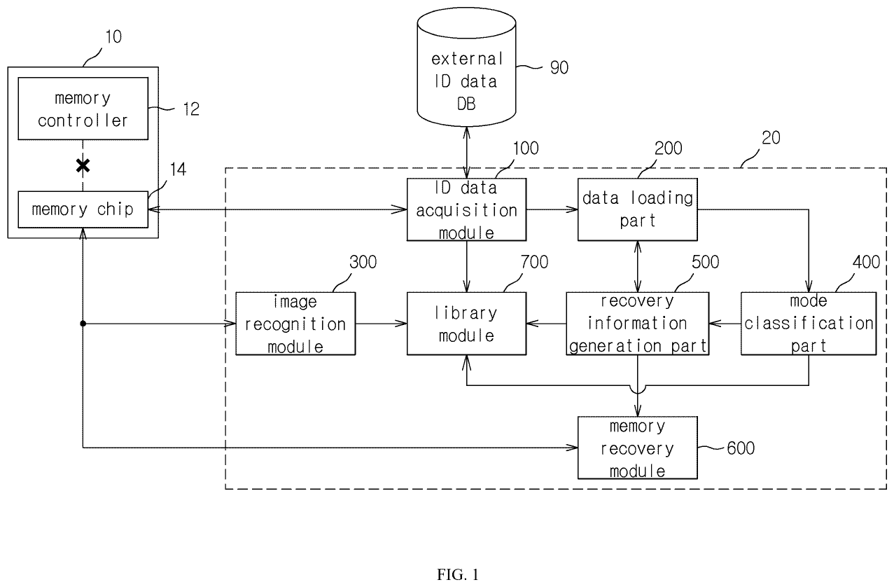

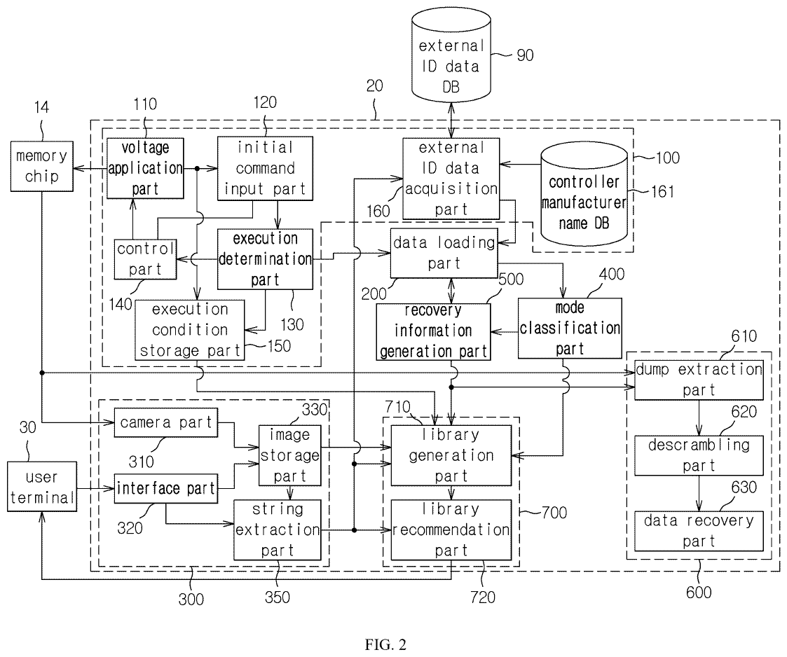

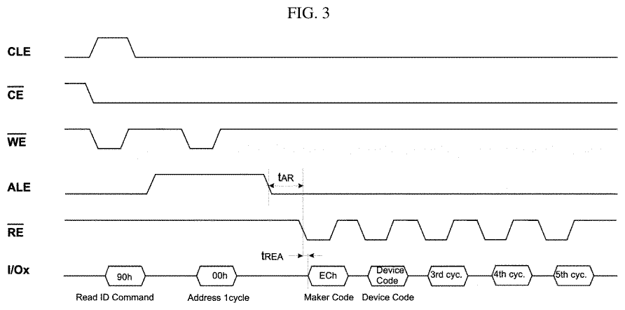

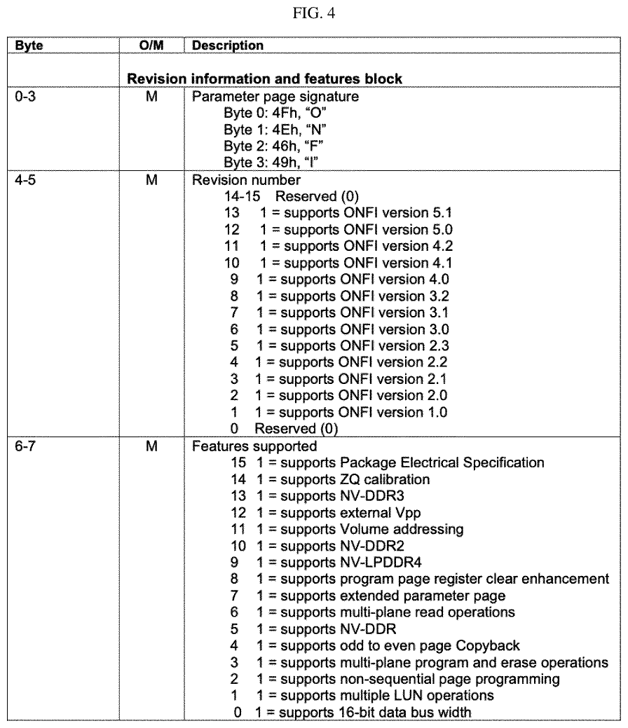

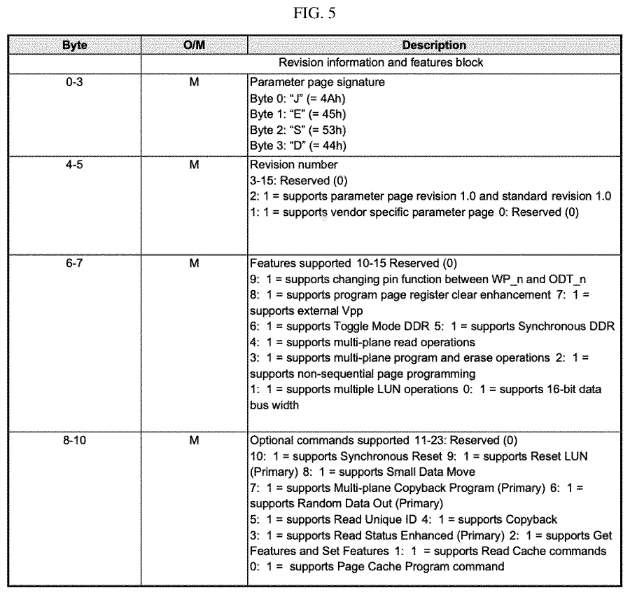

FIG. 1 is a conceptual diagram briefly illustrating an apparatus for generating data recovery information of NAND flash memory according to an embodiment of the present disclosure, FIG. 2 is a block diagram illustrating an apparatus for generating data recovery information of NAND flash memory according to an embodiment of the present disclosure, FIG. 3 is a diagram illustrating an operation timing chart of commands input by an initial command input part and a data loading part of FIG. 2, FIG. 4 is a diagram illustrating a part of a parameter page corresponding to a case of classification with a first classification value by a mode classification part of FIG. 2, and FIG. 5 is a diagram illustrating an example of a parameter page corresponding to a case of classification with a second classification value by a mode classification part of FIG. 2.

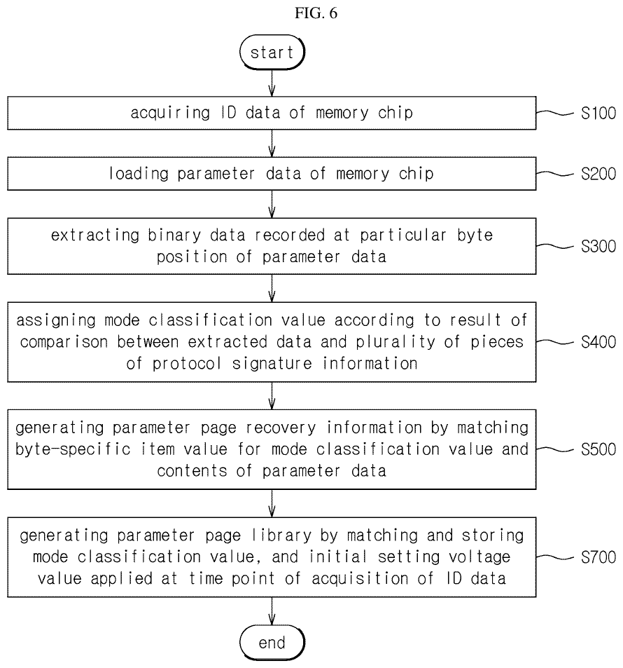

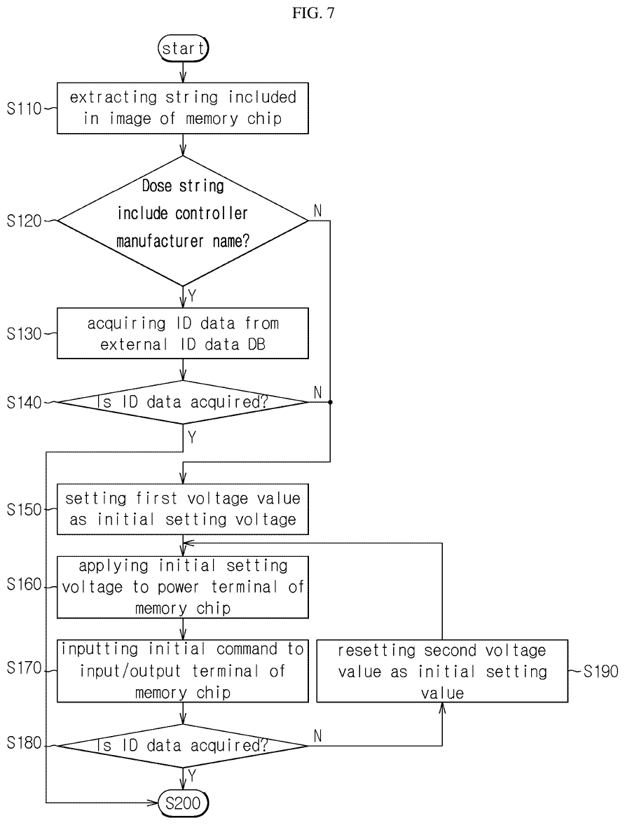

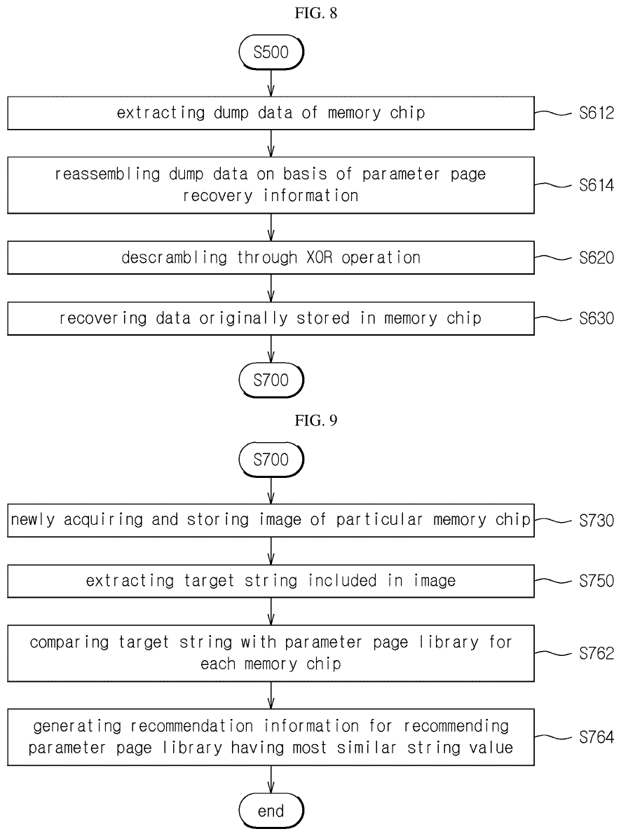

In addition, FIG. 6 is a flowchart illustrating a method for generating data recovery information of NAND flash memory according to another embodiment of the present disclosure, FIG. 7 is a flowchart illustrating step S100 of FIG. 6 in detail, FIG. 8 is a flowchart illustrating a data recovery process between step S500 and step S700 of FIG. 6, and FIG. 9 is a flowchart illustrating a library recommendation process after step S700 of FIG. 6.

Hereinafter, an apparatus and a method for generating data recovery information of NAND flash memory according to an exemplary embodiment of the present disclosure will be described as follows with reference to the aforementioned drawings.

The present disclosure relates to an apparatus and a method for generating data recovery information of NAND flash memory, the apparatus and the method recovering, in an environment in which a memory controller 12 of a NAND flash-type memory device 10 is unusable, data of a memory chip 14 within the memory device.

First, referring to FIG. 1, an apparatus 20 for generating data recovery information of NAND flash memory according to an embodiment of the present disclosure includes an ID data acquisition module 100, a data loading part 200, an image recognition module 300, a mode classification part 400, a recovery information generation part 500, a memory recovery module 600, and a library module 700.

The ID data acquisition module 100 determines whether a string extracted from an image of the front or back side of the memory chip 14 includes any one controller manufacturer name among a plurality of controller manufacturer names pre-stored in a controller manufacturer name DB 161. When it is determined that a controller manufacturer name is included in the string, the ID data acquisition module 100 provides the controller manufacturer name included in the string as a query to an external ID data DB 90, and acquires a controller product name and ID data corresponding to the controller manufacturer name provided as the query.

When a manufacturer name matched with the string extracted from the image of the front or back side of the memory chip 14 by a preset percentage (for example, 80%) or more is present in the controller manufacturer name DB 161, the ID data acquisition module 100 may determine that the controller manufacturer name is included in the string, and may provide the controller manufacturer name belonging to the controller manufacturer name DB 161 as the query to the external ID data DB 90.

Herein, the external ID data DB 90 is an online-accessible external database that pre-stores a controller product name and ID data for each of the memory products corresponding to controller manufacturer names, and outputs a controller product name and ID data corresponding to a controller manufacturer name when receiving the controller manufacturer name as a query.

The ID data acquisition module 100 may include the controller manufacturer name DB 161 in which the plurality of controller manufacturer names are pre-stored.

Preferably, the plurality of controller manufacturer names stored in the controller manufacturer name DB 161 are controller manufacturer names that can be found in the external ID data DB 90.

In the meantime, acquiring the image of the front or back side of the memory chip 14 and extracting the string of the acquired image may be performed through the image recognition module 300, which will be described later.

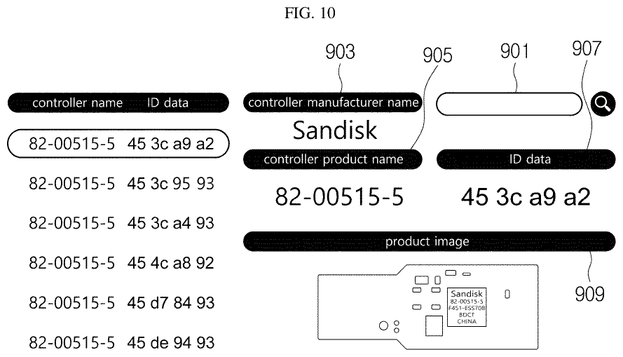

FIG. 10 is an example illustrating a user interface for searching the external ID data DB 90 for ID data. The external ID data DB 90 may provide a user interface. The user interface includes a search part 901 for receiving a controller manufacturer name and searching for a controller product name and ID data, a manufacturer name display area 903 for displaying the found controller manufacturer name, a controller product name display area 905 for displaying the controller product name corresponding to the found controller manufacturer name, an ID data display area 907 for displaying the ID data corresponding to the found controller manufacturer name, and a product image display area 909.

Through the above-described configuration, the apparatus 20 for generating data recovery information of NAND flash memory according to an embodiment of the present disclosure may acquire a controller product name and ID data corresponding to a controller manufacturer name by using the external ID data DB.

When the ID data is not acquired through the external ID data DB 90, the ID data acquisition module 100 may apply an initial setting voltage corresponding to a preset voltage level to a power terminal (VDD) of the memory chip 14, and may input an initial command value and an initial address value to an input/output terminal (I/Ox) of the memory chip 140, thereby acquiring ID data of the memory chip 14 according to the execution of an ID read command.

That is, when the ID data is not acquired through the external ID data DB 90, the ID data acquisition module 100 may check the operating voltage of the memory chip 14 to operate the memory chip 14 and then acquire the ID data of the memory chip 14.

Herein, the ID data may correspond to unique identification information for distinguishing one memory chip from another memory chip, and may include information, for example, a manufacturer ID, an identification code of a manufacturer, a device ID, and a device identification code.

Specifically, as shown in FIG. 2, the ID data acquisition module 100 may include a voltage application part 110, an initial command input part 120, an execution determination part 130, a control part 140, an execution condition storage part 150, an external ID data acquisition part 160, and the controller manufacturer name DB 161.

The voltage application part 110 sets a first voltage value corresponding to any one voltage level among a plurality of preset voltage levels as an initial setting voltage (V_{S}), and applies the initial setting voltage (V_{S}) to the power terminal (VDD) of the memory chip 14.

Herein, the initial setting voltage (V_{S}) refers to a voltage for setting the memory chip for operation, and the plurality of preset voltage levels may include 1.2 V, 1.8 V, and 3.3 V.

On the basis of a time point of applying the initial setting voltage (V_{S}), while the initial setting voltage (V_{S}) is applied, the initial command input part 120 inputs an initial command (C_{I}) including an initial command value and an initial address value to the input/output terminal (I/Ox) of the memory chip 14.

Herein, as shown in FIG. 3, the initial command (C_{I}) may include “90 h”, which is an initial command value indicating a read command (read ID command) for the ID data.

The execution determination part 130 determines whether the ID data of the memory chip 14 is acquired according to the execution of the ID read command corresponding to the input of the initial command (C_{I}).

The execution determination part 130 may determine whether the ID data is loaded according to the initial command value (“90 h”).

The control part 140 determines whether ID data is acquired after the external ID data acquisition part 160 generates and transmits a query to the external ID data DB 90, and when it is determined that the ID data is not acquired after the query is transmitted, the control part 140 controls the operation of the voltage application part 110 and the initial command input part 120 to acquire the ID data of the memory chip 14.

The control part 140 may control the operation of the voltage application part 110 and the initial command input part 120 to acquire the ID data of the memory chip 14 on the basis of a result of determination by the execution determination part 130.

The control part 140 may control the voltage application part 110 and the initial command input part 120 to repeatedly perform an operation in which when the ID data is not acquired as the result of determination by the execution determination part 130, a second voltage value having a different voltage level from the currently set initial setting voltage (V_{S}) among the plurality of voltage levels is reset as the initial setting voltage (V_{S}) and applied to the power terminal (VDD) and then the initial command (C_{I}) is re-input to the input/output terminal (I/Ox), until the ID data is acquired.

For example, if the initial command (C_{I}) is input while the first voltage value (1.8V) is set as the initial setting voltage (V_{S}) of the memory chip 14 and applied, but the ID data is not acquired as a result of determination, the control part 140 may control the voltage application part 110 to reset the second voltage value (3.3V) as the initial setting voltage (V_{S}) and apply the initial setting voltage to the voltage terminal (VDD), and may control the initial command input part 120 to re-input the initial command (C_{I}) while the reset initial setting voltage (V_{S}) is applied.

Herein, the ID data acquisition module 100 may further include the configuration of the execution condition storage part 150 that, when the execution determination part 130 determines that the ID data is acquired, stores the voltage value, that is, the value of the initial setting voltage (V_{S}), applied to the voltage terminal (VDD) of the memory chip 14 at the time point at which the ID data is acquired, as voltage condition information under which the memory chip 14 can operate and execute commands.

The external ID data acquisition part 160 determines whether a string extracted from an image of the front or back side of the memory chip 14 includes any one of the plurality of controller manufacturer names pre-stored in the controller manufacturer name DB 161. When it is determined that a controller manufacturer name is included in the string, the external ID data acquisition part 160 provides the controller manufacturer name included in the string is provided as a query to the external ID data DB 90, and acquires the controller product name and the ID data corresponding to the controller manufacturer name provided as the query.

The controller manufacturer name DB 161 stores, as strings or text, controller manufacturer names that can be found in the external ID data DB 90.

The data loading part 200 is for loading parameter data (D_{P}) of the memory chip 14 after the acquisition of the ID data is determined.

The data loading part 200 inputs, when ID data is acquired, a command (C_{P}) for calling a parameter page area of the memory chip 14 to the input/output terminal (I/Ox) of the memory chip 14 to load parameter data (D_{P}) stored in the parameter page area.

Herein, as shown in FIG. 3, the command (C_{P}) for calling the parameter page area may include “ECh”, which is a call command value indicating a call command for a parameter page that includes a manufacturer code (make code) and a device code.

The command (C_{P}) for calling a parameter page area may be a command predetermined for each manufacturer corresponding to ID data.

The image recognition module 300 acquires an image of the front or back side of the memory chip 14, extracts a string included in the image, and provides the image and the extracted string to the ID data acquisition module 100 and the library module 700.

The image recognition module 300 may include a camera part 310, an interface part 320, an image storage part 330, and a string extraction part 350.

The camera part 310 acquires an image obtained by capturing the front or back side of the memory chip 14 and forwards the image to the image storage part 330.

The interface part 320 receives the image of the front or back side of the memory chip 14 from a user through a user terminal 30 and forwards the image to the image storage part 330.

The image storage part 330 acquires and store the image forwarded from the camera part 310 or the interface part 320.

The string extraction part 350 uses a preset string extraction algorithm to extract the string included in the image stored in the image storage part 330.

The mode classification part 400 is for determining a mode classification value (M) for the memory chip 14 on the basis of protocol information included in the parameter data (D_{P}).

The mode classification part 400 extracts binary data recorded at a particular byte position of the parameter data (D_{P}) loaded by the data loading part 200.

Herein, preferably, the binary data extracted by the mode classification part 400 is the first to fourth byte data of the parameter data (D_{P}).

In the meantime, the mode classification part 400 may convert the extracted binary data into an ASCII code-based string.

In this case, the mode classification part 400 converts the first byte data, the second byte data, the third byte data, and the fourth byte data of the parameter data (D_{P}) into a first string (S1), a second string (S2), a third string (S3), and a fourth string (S4), respectively.

The mode classification part 400 assign the mode classification value (M) according to a result of comparison between the extracted binary data or the string data resulting from conversion and a plurality of pieces of preset protocol signature information.

Herein, the plurality of protocol signature information may include “ONFI”, which is an abbreviation for the Open NAND Flash Interface Working Group, and “JESD”, which is an abbreviation for a memory standard document (JEDEC standard) published by the Joint Electron Device Engineering Council (JEDEC).

When using binary data as a comparison target, the mode classification part 400 compares the first byte data of the parameter data (D_{P}) with each of the values resulting from binary conversion of the first string (“O” and “J”) of the protocol signature information, the second byte data of the parameter data (D_{P}) with each of the values resulting from binary conversion of the second string (“N” and “E”) of the protocol signature information, the third byte data of the parameter data (D_{P}) with the values resulting from binary conversion of the third string (“F” and “S”) of the protocol signature information, and the fourth byte data of the parameter data (D_{P}) with the values resulting from binary conversion of the fourth string (“I” and “D”) of the protocol signature information.

When using string data as a comparison target, the mode classification part 400 compares the first string (S1) with “O” and “J”, the first string of the protocol signature information, the second string (S2) with “N” and “E”, the second string of the protocol signature information, the third string (S3) with “F” and “S”, the third string of the protocol signature information, and the fourth string (S4) with “I” and “D”, the fourth string of the protocol signature information.

The mode classification part 400 assigns a first classification value as the mode classification value (M) when a result of above-described comparison corresponds to “ONFI”, a second classification value when the result corresponds to “JESD”, or a third classification value when the result corresponds to neither the first classification value nor the second classification value.

On the basis of parameter page length and byte-specific item value information preset in association with the mode classification value (M) assigned by the mode classification part 400, the recovery information generation part 500 generates parameter page recovery information (I_{R}) by matching, in byte order, a byte-specific item value for the mode classification value (M) with the contents of the parameter data (D_{P}) loaded by the data loading part 200.

Herein, a DB that stores table data of a parameter page corresponding to the first classification value (ONFI) shown in FIG. 4 and table data of a parameter page corresponding to the second classification value (JESD) shown in FIG. 5 separately by classification value may be further included.

Herein, the table data of the parameter page may be table data in which byte numbers and item value information are mapped and stored, and the parameter page length may be determined by the last byte number corresponding to the bottommost item of the table.

For example, the last byte number for the bottommost item of the parameter page table for “ONFI” is ‘767’, and the last byte number for the bottommost item of the parameter page table for “JESD” is ‘1535’, so the parameter page lengths of the first classification value (ONFI) and the second classification value (JESD) are different.

The data recovery module 600 is for recovering the data originally stored in the memory chip 14, on the basis of the parameter page recovery information (I_{R}).

The data recovery module 600 may recover the data originally stored in the memory chip 14 by reassembling dump data of the memory chip 14 on the basis of the parameter page recovery information (I_{R}).

As shown in FIG. 2, the data recovery module 600 includes a dump extraction part 610, a descrambling part 620, and a data recovery part 630. The dump extraction part 610 may perform an operation of extracting dump data of the memory chip 14. The descrambling part 620 may perform an operation of reassembling the extracted dump data on the basis of parameter recovery information (I_{R}) and then performing descrambling through an XOR operation. The data recovery part 630 may perform an operation of recovering the data originally stored in the memory chip 14, on the basis of the descrambled data.

The library module 700 is for building a library for parameter page information of the memory chip 14.

Specifically, as shown in FIG. 2, the library module 700 may further include a library generation part 710, and a library recommendation part 720.

The library generation part 710 may generate and store a parameter page library (L) by matching and storing the parameter page recovery information (I_{R}), the initial setting voltage value (V_{S}) applied to the power terminal (VDD) at the time point at which the ID data of the memory chip 14 is acquired, and the mode classification value (M) assigned in association with the parameter page.

In this case, the library generation part 710 may generate and store a parameter page library (L) for each memory chip by matching and storing the parameter page recovery information (I_{R}), the initial setting voltage value (V_{S}), and the mode classification value (M) described above together with the image stored in association with the memory chip 14 and the string value extracted from the image.

The library recommendation part 720 is for recommending a parameter page library of a memory chip similar to a newly stored memory chip image on the basis of a pre-stored parameter page library.

When the image storage part 330 newly stores a chip image of a particular memory chip and the string extraction part 350 extracts a target string included in the chip image, the library recommendation part 720 may generate recommendation information for recommending a parameter page library having the most similar string value, on the basis of a result of comparison between the extracted target string and a parameter page library for each h memory chip pre-stored by the library generation part 710.

Herein, preferably, the pre-stored parameter page library pre-stores a string value extracted from a memory chip image is pre-stored for each memory chip.

On the basis of the above description of the elements shown in FIGS. 1 and 2, a method for generating data recovery information of NAND flash memory according to the present disclosure will be described with reference to FIGS. 6 to 9 as follows.

A method for generating data recovery information of NAND flash according to an embodiment of the present disclosure may include an ID data acquisition step S100, a parameter data loading step S200, a binary data extraction step S300, a mode classification value assignment step S400, a recovery information generation step S500, a memory recovery step S600, and a library generation step S700.

First, the ID data acquisition step S100 is for acquiring ID data of the memory chip 14.

Herein, the ID data may correspond to unique identification information for distinguishing one memory chip from another memory chip, and may include information, for example, a manufacturer ID, an identification code of a manufacturer, a device ID, and a device identification code.

In step S100, the ID data may be acquired through the external ID data DB, or the ID data of the memory chip 14 may be acquired according to the execution of an ID read command by applying the initial setting voltage corresponding to the preset voltage level to the power terminal (VDD) of the memory chip 14 and inputting the initial command value and the initial address value to the input/output terminal (I/Ox) of the memory chip 14.

Specifically, as shown in FIG. 7, step S100 may include: acquiring and storing an image obtained by capturing the front side of the memory chip 14 or an image obtained by capturing the front side of the memory chip 14 according to a user input, and using a preset string extraction algorithm to extract a string included in the image stored in association with the memory chip 14 in step S110; determining whether the extracted string includes a controller manufacturer name in step S120; providing, when it is determined that the extracted string includes the controller manufacturer name, the controller manufacturer name included in the string as a query to the external ID data DB 90, and acquiring a controller product name and ID data corresponding to the controller manufacturer name provided as the query in step S130; determining whether the ID data is acquired from the external ID data 90 in step S140; setting a first voltage value as an initial setting voltage (V_{S}) when it is determined that the ID data is not acquired from the external ID data 90 in step S150; applying the set initial setting voltage (V_{S}) to the power terminal (VDD) of the memory chip 14 in step S160; inputting an initial command (C_{I}) to the input/output terminal (I/Ox) of the memory chip 14 in step S170; determining whether the ID data of the memory chip 14 is acquired according to the execution of an ID read command corresponding to corresponding to the input of the initial command (C_{I}) in step S180; resetting, when the ID data is not acquired as a result of determination in step S180, a second voltage value having a different voltage level from the currently set initial setting voltage (V_{S}) among a plurality of voltage levels as the initial setting voltage (V_{S}) in step S190; and performing control such that steps S160, S170, S180, and S190 are repeatedly performed until the ID data is acquired.

Herein, the initial setting voltage (V_{S}) refers to a voltage for setting the memory chip for operation, and the plurality of preset voltage levels may include 1.2 V, 1.8 V, and 3.3 V.

Herein, as shown in FIG. 3, the initial command (C_{I}) may include “90 h”, which is an initial command value indicating a read command (read ID command) for the ID data.

In step S180, it may be determined whether the ID data is loaded according to the initial command value (“90 h”).

Herein, the method may further include storing (not shown), when it is determined that the ID data is acquired, the voltage value, that is, the value of the initial setting voltage (V_{S}), applied to the voltage terminal (VDD) of the memory chip 14 at the time point at which the ID data is acquired, as the voltage condition information under which the memory chip 14 can operate and execute commands.

Next, the parameter data loading step S200 is for loading the parameter data (D_{P}) of the memory chip 14 after the acquisition of the ID data in step S100 is determined.

In step S200, when the ID data is acquired as a result of determination in step S180, the command (C_{P}) for calling the parameter page area of the memory chip 14 to the input/output terminal (I/Ox) of the memory chip 14 to load the parameter data (D_{P}) stored in the parameter page area.

Herein, as shown in FIG. 3, the command (C_{P}) for calling the parameter page area may include “ECh”, which is a call command value indicating a call command for a parameter page that includes a manufacturer code (make code) and a device code.

Next, in the binary data extraction step S300, the binary data recorded at a particular byte position of the parameter data (D_{P}) loaded in step S200 is extracted.

Herein, preferably, the binary data extracted in step S300 is the first to fourth byte data of the parameter data (D_{P}).

In addition, the method may further include converting the binary data extracted in step S300 into an ASCII code-based string in step S350.

In this case, in step S350, the first byte data, the second byte data, the third byte data, and the fourth byte data of the parameter data (D_{P}) are converted into a first string (S1), a second string (S2), a third string (S3), and a fourth string (S4), respectively.

Next, the mode classification value assignment step S400 is for determining the mode classification value (M) for the memory chip 14 on the basis of the protocol information included in the parameter data (D_{P}).

In step S400, the mode classification value (M) is assigned according to a result of comparison between the binary data extracted in step S300 or the string data resulting from conversion in step S350 and a plurality of pieces of preset protocol signature information.

Herein, the plurality of protocol signature information may include “ONFI”, which is an abbreviation for the Open NAND Flash Interface Working Group, and “JESD”, which is an abbreviation for a memory standard document (JEDEC standard) published by the Joint Electron Device Engineering Council (JEDEC).

In step S400, when using the binary data extracted in step S300 as a comparison target, the first byte data of the parameter data (D_{P}) is compared with each of the values resulting from binary conversion of the first string (“O” and “J”) of the protocol signature information, the second byte data of the parameter data (D_{P}) is compared with each of the values resulting from binary conversion of the second string (“N” and “E”) of the protocol signature information, the third byte data of the parameter data (D_{P}) is compared with the values resulting from binary conversion of the third string (“F” and “S”) of the protocol signature information, and the fourth byte data of the parameter data (D_{P}) is compared with the values resulting from binary conversion of the fourth string (“I” and “D”) of the protocol signature information.

In step S400, when using the string data resulting from conversion in step S350 as a comparison target, the first string (S1) is compared with “O” and “J”, the first string of the protocol signature information, the second string (S2) is compared with “N” and “E”, the second string of the protocol signature information, the third string (S3) is compared with “F” and “S”, the third string of the protocol signature information, and the fourth string (S4) is compared with “I” and “D”, the fourth string of the protocol signature information.

In step S400, when a result of above-described comparison corresponds to “ONFI”, the first t classification value is assigned as the mode classification value (M), or when the result corresponds to “JESD”, the second classification value is assigned as the mode classification value (M), or when the result corresponds to neither the first classification value nor the second classification value, the third classification value is assigned as the mode classification value (M).

Next, in the recovery information generation step S500, on the basis of the parameter page length and byte-specific item value information preset in association with the mode classification value (M) assigned in step S400, the parameter page recovery information (I_{R}) is generated by matching, in byte order, the byte-specific item value for the mode classification value (M) and the contents of the parameter data (D_{P}) loaded by the data loading part 200.

Herein, between step S400 and step S500, the method may further include storing (not shown) the table data of the parameter page corresponding to the first classification value (ONFI) shown in FIG. 4 and the table data of the parameter page corresponding to the second classification value (JESD) shown in FIG. 5 separately by classification value.

Herein, the table data of the parameter page may be table data in which byte numbers and item value information are mapped and stored, and the parameter page length may be determined by the last byte number corresponding to the bottommost item of the table.

Next, the memory recovery step (S600) is for recovering the data originally stored in the memory chip 14, on the basis of the parameter page recovery information (I_{R}) generated in step S500.

In step S600, the dump data of the memory chip 14 may be extracted and reassembled on the basis of the parameter page recovery information (I_{R}), and then descrambling may be performed through an XOR operation to recover the data originally stored in the memory chip 14.

Specifically, as shown in FIG. 8, step S600 may include: extracting the dump data of the memory chip 14 in step S612; reassembling the extracted dump data on the basis of the parameter recovery information (I_{R}) and then performing descrambling through the XOR operation in steps S614 to S620; and recovering the data originally stored in the memory chip 14, on the basis of the descrambled data in step S630.

Next, the library generation step S700 is for building a library for parameter page information of the memory chip 14.

In step S700, the parameter page library (L) is generated and stored by matching and storing the parameter page recovery information (I_{R}), the initial setting voltage value (V_{S}) applied to the power terminal (VDD) at the time point at which the ID data of the memory chip 14 is acquired, and the mode classification value (M) assigned in association with the parameter page.

Herein, before step S700, the method may further include: acquiring and storing the image obtained by capturing the front side of the memory chip 14 or the image obtained by capturing the front side of the memory chip 14 according to the user input in step S730; and using the preset string extraction algorithm to extract the string included in the image stored in association with the memory chip 14 in step S750.

Herein, in step S730, the image obtained by capturing the front or back side of the memory chip 14 through the camera may be acquired and stored, or the image of the front or back side of the memory chip 14 input from the user through the user terminal 30 may be acquired and stored.

Herein, step S750 is for extracting the string included in the memory chip image stored in step S730 by using the preset string extraction algorithm.

In this case, in step S700, the parameter page library (L) may be generated and stored for each memory chip by matching and storing the parameter page recovery information (I_{R}) for the memory chip 14, the voltage value (V_{S}) applied to the power terminal (VDD) at the time point at which the ID data of the memory chip 14 is acquired, and the mode classification value (M) assigned in association with the parameter page of the memory chip 14, together with the image stored in association with the memory chip 14 and the string value extracted from the image in steps S730 and S750.

In the meantime, a method for generating data recovery information of NAND flash memory according to an embodiment of the present disclosure may further include a library recommendation process (S762 and S764) shown in FIG. 9, in addition to the above-described processes.

The library recommendation process is performed on the premise that each memory chip image and a string value extracted therefrom are matched and stored in the parameter page library for each memory chip stored in step S700. Specifically, the library recommendation process may include: newly acquiring and storing a chip image for a particular memory chip in step S730; extracting a target string included in the stored chip image by using a preset string extraction algorithm in step S750; and generating recommendation information for recommending a parameter page library having the most similar string value, on the basis of a result of comparison between the extracted target string and a parameter page library for each memory chip in step S764.

Accordingly, according to the above-described present disclosure, even when physical damage or failure occurs in an internal controller of a NAND flash memory device, making the internal controller unusable, the memory chip can operate and execute commands, thereby acquiring parameter data required for recovering data.

In addition, according to the present disclosure, a parameter page library for each memory chip can be built, so information required for recovering the data of the memory can be acquired in a short time using only a memory chip image or data recorded in the memory chip.

Although the present disclosure has been described in detail through exemplary embodiments, the present disclosure is not limited thereto and may be implemented in various ways within the scope of the claims.

In particular, features and technical advantages of the present disclosure have been widely described for better understanding of the scope of the claims. Therefore, it should be recognized by those skilled in the art that concepts and a particular embodiment of the present disclosure described above may readily be used as a basis for designing or modifying other configurations for carrying out the similar purposes as the present disclosure.

In addition, an embodiment described above is merely one embodiment of the present disclosure, and it will be understood that various modifications and changes may be made within the scope of the technical idea of the present disclosure by those skilled in the art. Accordingly, the disclosed embodiments should be considered in a descriptive rather than limiting sense, and such various modifications and changes are also within the scope of the technical idea of the present disclosure, as set forth in the claims, and all differences within equivalent scopes should be construed as being included in the present disclosure.

### INDUSTRIAL APPLICABILITY

the present disclosure can be applied to industrial fields for recovering memory data in an environment in which an internal controller of a NAND flash memory device is unusable, by enabling parameter data of the memory to be loaded.

1. An apparatus for generating data recovery information of NAND flash memory, wherein in an environment in which a memory controller of a NAND flash-type memory device is unusable, the apparatus generates recovery information by recovering data in the memory device, the apparatus comprising:
an image storage part configured to acquire and store either an image obtained by capturing a front side of a memory chip or an image of the front side of the memory chip according to a user input;
a string extraction part configured to use a preset string extraction algorithm to extract a string included in the image stored in the image storage part;
an ID data acquisition module configured to determine whether the string extracted by the string extraction part includes any one controller manufacturer name among a plurality of preset controller manufacturer names, and provide the controller manufacturer name included in the string as a query to an external ID data DB when it is determined that the string includes the manufacturer name, and acquire a controller product name and ID data corresponding to the controller manufacturer name provided as the query, wherein the external ID data DB pre-stores the controller product name and the ID data for each memory product corresponding to the controller manufacturer name and outputs the controller product name and the ID data when the controller manufacturer name is provided as the query;
a data loading part configured to input, when the ID data is acquired, a call command value and a call address value that are a command for calling a parameter page area of the memory chip to an input/output terminal of the memory chip and load parameter data stored in the parameter page area;
a mode classification part configured to extract binary data recorded at a particular byte position of the loaded parameter data and assign a mode classification value according to a result of comparison with a plurality of pieces of preset protocol signature information; and
a recovery information generation part configured to generate parameter page recovery information by matching a byte-specific item value for the mode classification value and contents of the parameter data in byte order on the basis of parameter page length and byte-specific item value information preset in association with the assigned mode classification value.

2. The apparatus of claim 1, wherein the ID data acquisition module is configured to, when the ID data is not acquired through the external ID data DB, apply an initial setting voltage corresponding to a preset voltage level to a power terminal of the memory chip and input an initial command value and an initial address value to the input/output terminal of the memory chip and acquire the ID data of the memory chip according to execution of a ID read command.

3. The apparatus of claim 2, further comprising:
a library generation part configured to generate and store a parameter page library by matching and storing the parameter page recovery information, a voltage value applied to the power terminal at a time point at which the ID data acquisition module acquires the ID data, and the mode classification value assigned in association with a parameter page.

4. The apparatus of claim 1, further comprising:
a data recovery module configured to extract dump data of the memory chip and reassemble the extracted dump data on the basis of the parameter page recovery information, and then perform descrambling through an XOR operation, thereby recovering data originally stored in the memory chip.

5. The apparatus of claim 1, wherein the command for calling the parameter page area is a command predetermined for each manufacturer corresponding to the ID data.
